(19) United States
(12) Patent Application Publication
(10) Pub. No.: US 2026/0121020 A1
(43) Pub. Date: Apr. 30, 2026

(54) RECHARGEABLE BATTERIES, LITHIUM-ION BATTERIES, ELECTRODES, AND LOW-TEMPERATURE ELECTROLYTES

(71) Applicant: Purdue Research Foundation, West Lafayette, IN (US)

(72) Inventors: Vilas Ganpat Pol, West Lafayette, IN (US); Brian Michael Tackett, Lafayette, IN (US); Daecheol Jeong, West Lafayette, IN (US)

(21) Appl. No.: 19/370,056

(22) Filed: Oct. 27, 2025

Related U.S. Application Data
(60) Provisional application No. 63/713,551, filed on Oct. 29, 2024.

(51) Int. Cl. H01M 4/133; H01M 4/02; H01M 4/134; H01M 4/36; H01M 4/38; H01M 4/587; H01M 4/62; H01M 10/0525; H01M 10/0568; H01M 10/0569

(52) U.S. Cl. CPC H01M 4/133; H01M 4/134; H01M 4/366; H01M 4/38; H01M 4/587; H01M 4/623; H01M 4/625; H01M 10/0525; H01M 10/0568; H01M 10/0569; H01M 2004/021; H01M 2004/027; H01M 2300/0028

(57) ABSTRACT

Rechargeable batteries, lithium-ion batteries, electrodes, and low-temperature electrolytes. The electrodes contain MXene, such as Ti₃C₂Tₓ where Ti₃ denotes three layers of Ti, C₂ denotes two layers of carbon interleaved with the three layers of Ti, and Tₓ denotes surface terminations of F, O, OH, and/or Cl. The batteries include the electrode as an anode. The low-temperature electrolytes are dipropyl ether (DPE)-based electrolytes that include an amount of dipropyl ether sufficient to remain in liquid form at extremely low temperatures. The batteries may include the DPE-based electrolyte.

### CROSS-REFERENCE TO RELATED APPLICATIONS

This application claims the benefit of provisional U.S. Patent Application No. 63/713,551 filed Oct. 29, 2024, the contents of which are incorporated herein by reference.

### BACKGROUND OF THE INVENTION

The invention generally relates to electrochemical battery technology, and more particularly to rechargeable batteries, lithium-ion batteries, electrodes for lithium-ion batteries, low-temperature electrolytes for electrochemical cells, and associated components, products, and methods.

Rechargeable electrochemical batteries, such as lithium-ion batteries (also referred to herein as “LI batteries” and “LIBs”), are used for storing and supplying electric power in many devices that are used in cold and extreme cold conditions. For example, rechargeable LI batteries may be incorporated into applications used in cold weather (e.g., electric automobiles), and extreme cold environments, such as undersea (e.g., submarines) and in deep space (e.g., space craft). Conventional LI batteries have graphite anodes.

Conventional LI batteries typically include four primary elements: a cathode, an anode, a porous separator that electronically separates electrodes but allows ion migration, and an ionically conductive electrolyte to facilitate ion migration between the cathode and the anode. The fundamental operation of LIBs is based on the intercalation and deintercalation of lithium ions and their transfer between the anode and cathode during the charging and discharging cycles. For instance, the most common LIB system is composed of a transition metal oxide cathode, a graphite anode, and an electrolyte of lithium salts dissolved in an organic solvent. During the charging process, Li⁺ ions are extracted from the cathode material, diffuse through the electrolyte, and intercalate between the graphite layers of the anode. This process is facilitated by the movement of lithium ions through the electrolyte, which usually contains a lithium salt dissolved in organic solvents. However, the performance of LIBs significantly degrades at low temperatures below 0° C. due to various factors that reduce the capacity of the battery by limiting its ability to store and transfer charge at low temperatures, thereby severely limiting their utility in cold environments below 0° C., and sometimes making them unusable in extreme cold environments below −50° C. For example, power storage and/or supply performance can decline due to increased charge-transfer resistance, electrolyte solidification, and sluggish diffusion of lithium ions within the electrode, which can lead to incomplete intercalation and enhanced dendrite formation.

Therefore, it would be desirable to have rechargeable battery technology that is capable of improving performance power storage and/or power supply of the batteries in cold and extremely cold conditions.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, rechargeable batteries, lithium-ion batteries, electrodes for lithium-ion batteries, and low-temperature electrolytes for electrochemical cells, as well as components, products, and methods related thereto.

According to a nonlimiting aspect, an electrode for a lithium-ion battery includes MXene, wherein the MXene is Ti₃C₂Tₓ, where Ti₃ denotes three layers of Ti, C₂ denotes two layers of carbon interleaved with the three layers of Ti, and Tₓ denotes surface terminations of F, O, OH, and/or Cl.

According to another nonlimiting aspect, a lithium-ion battery includes an electrode comprising MXene, wherein the MXene is Ti₃C₂Tₓ.

According to yet another nonlimiting aspect, a rechargeable battery includes an anode comprising MXene, a cathode, and a DPE-based electrolyte ionically coupling the anode with the cathode, wherein the electrolyte is a solution of lithium bis(fluorosulfonyl)imide (LiFSI) in dipropyl ether.

According to still another nonlimiting aspect, a low-temperature electrolyte for an electrochemical cell includes a sufficient quantity of dipropyl ether to not freeze at a temperature of −70° C.

Technical aspects of rechargeable batteries, lithium-ion batteries, electrodes, low-temperature electrolytes, and/or associated as components, products, and methods as described above preferably include the ability to exhibit improved power storage and/or power supply performance in cold and extremely cold conditions.

These and other aspects, arrangements, features, and/or technical effects will become apparent upon detailed inspection of the figures and the following description.

### BRIEF DESCRIPTION OF THE DRAWINGS

FIG. 1 is a schematic exploded view of the interior of a rechargeable lithium-ion battery with at least one MXene electrode exemplifying some nonlimiting aspects of the invention.

FIG. 2 is a schematic drawing of an MXene.

FIG. 3 includes images of an MXene at different magnifications: the scale bar in the left image represents 2 μm; the scale bar in the right image represents 400 nm.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments and/or aspects of the invention, and to describe certain but not all aspects of the embodiment(s) to which the drawings relate. The following detailed description also describes certain investigations relating to the embodiment(s) and identifies certain but not all alternatives of the embodiment(s). As nonlimiting examples, the invention encompasses additional or alternative embodiments in which one or more features or aspects shown and/or described as part of a particular embodiment could be eliminated and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

Although the invention will be described hereinafter in reference to the rechargeable lithium-ion coin cell shown in the drawings, it will be appreciated that the teachings of the invention are more generally applicable to a variety of types of batteries that may benefit from improved performance at low temperatures.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

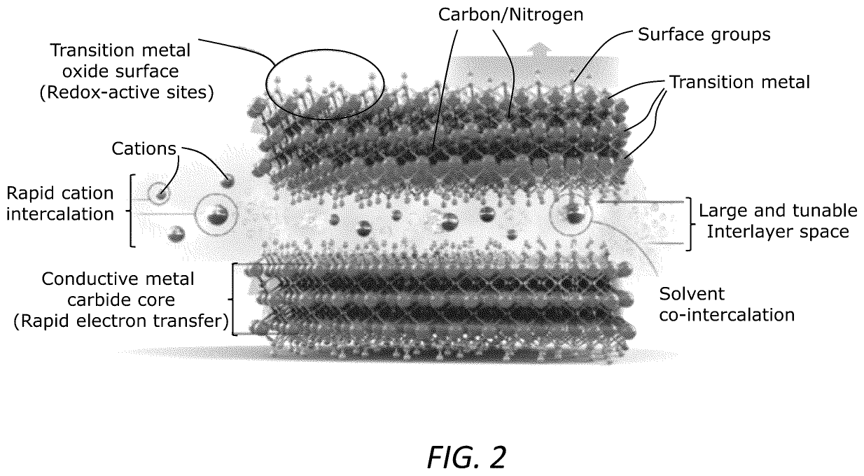

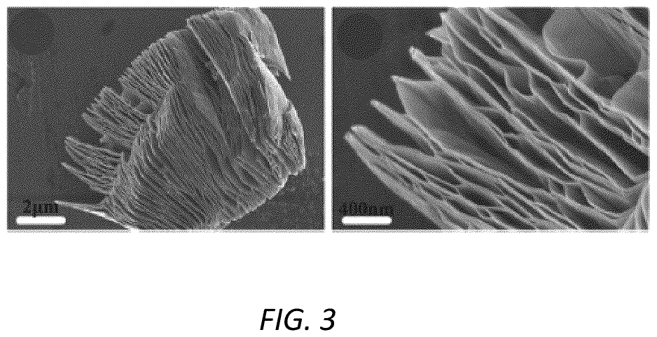

Presented herein are electrodes for batteries (electrochemical cells), as well as batteries including such electrodes, in which the electrode is made with an MXene. MXenes are a known family of two-dimensional (“2D”) early transition metal carbides and nitrides. The 2D structure of MXene is described by the formula, Mn+1XₙTₓ, and is generally constructed by n+1 layers of early transition metals (labeled as M) (most commonly Ti, Zr, Hf, V, or Nb) interleaved by n layers of carbon or nitrogen (labeled as X) and surface terminations such as F, O, OH, or Cl (labeled as Tₓ). MXenes are multilayered structures, an example of which is shown in FIG. 3. In comparison to graphitic materials, MXenes have enhanced conductivities that promote ion transport and surface redox reactions. Unlike traditional anode materials relying on solid-state ion diffusion, anodes made with MXenes can improve lithium-ion storage kinetics through surface-confined redox activity, thereby addressing the limitations of LIBs under low temperature. The MXene is preferably Ti₃C₂Tₓ. As illustrated diagrammatically in FIG. 2, the Ti₃ denotes the presence of three layers of Ti, C₂ denotes the presence of two layers of carbon interleaved with the three layers of Ti, and Tₓ denotes the presence of surface terminations of F, O, OH, and/or Cl. However, different configurations and forms of MXene could be utilized in other embodiments.

The battery is a lithium-ion (LI) battery, such as a rechargeable LI battery. The battery includes additional components, such as a second electrode, an electrolyte for transporting ions between the two electrodes, and/or a porous separator to electronically separate the two electrodes from each other while also allowing ion migration back and forth from one electrode to the other electrode. The electrode made with MXene forms the anode, while the second electrode forms the cathode. The cathode may be any suitable cathode, such as a copper and/or lithium cathode.

The electrolyte is preferably a dipropyl ether (DPE)-based electrolyte, such as an electrolyte formed from a solution of lithium bis(fluorosulfonyl)imide (LiFSI) and dipropyl ether; however, in some configurations, other suitable electrolytes may be used, such as a mixture of ethylene carbonate (EC) and ethyl methyl carbonate (EMC).

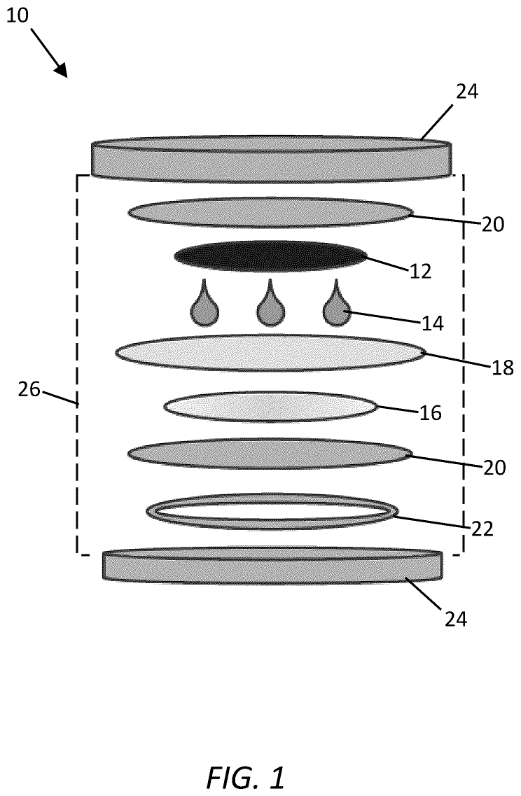

Turning now to the nonlimiting example shown in FIG. 1, a battery 10 has an anode 12 that contains MXene. The battery 10 is preferably a rechargeable battery, such as a rechargeable lithium-ion battery. The MXene in this example is Ti₃C₂Tₓ. In this example, the battery 10 is in the form factor of a typical coin cell, and the anode 12 has the form of a generally circular sheet of the multi-layered MXene. However, the battery 10 and/or the anode 12 may take other shapes or forms appropriate for a battery of a given form factor. The anode 12 is preferably made from a mixture of MXene (e.g., Ti₃C₂Tₓ), conductive carbon black (e.g., Super P carbon black powder), and a binder (e.g., polyvinylidene fluoride) dissolved in a solvent (e.g., N-Methyl Pyrrolidone). The mixture may be homogenized to form a slurry that can be cast and dried to form an electrode sheet, which may then be cut and/or otherwise manipulated to form the anode 12 in any desired form factor. In this example, the electrode sheet was punched into circular disks for assembly into a coin cell. An effective MXene loading is believed to be about 1.5 mg/cm², though other amounts of MXene and/or other components may be incorporated into the electrode sheet.

An electrolyte 14 is operatively disposed between the anode 12 and a cathode 16 to ionically couple the anode to the cathode so as to transport ions from the anode to cathode and/or from the cathode to the anode, depending on whether the battery is electrically discharging or being electrically charged. The electrolyte is preferably a lithium-bearing electrolyte. In some configurations, the electrolyte 14 is a dipropyl ether (DPE)-based electrolyte. For example, the DPE-based electrolyte may include lithium bis(fluorosulfonyl)imide (LiFSI) dissolved in the dipropyl ether.

The cathode 16 may be made of any suitable material. For example, the cathode may be made of copper and/or lithium. In this arrangement where the battery 10 is in the form of a LI coin cell, the cathode 16 is in the form of a circular disc of lithium-copper foil; however, other materials, shapes, and/or types of cathodes could be used.

Additional components of the battery 10 may be included as appropriate and/or desired for a given type and/or form factor. In this arrangement, the battery 10 also includes a separator 18 formed of a suitable thin microporous membrane that can electronically separate the cathode 16 from the anode 12 and also allows the ion migration from the cathode to the anode and back. The separator may be a conventional polypropylene separator, such as a Celgard® polypropylene separator. The battery 10 may include additional components, such as, one or more spacers 20, springs 22, end caps 24 (e.g., a cathode cap and an anode cap), and/or outer casings 26, in any operatively suitable configurations as would be well understood in the art.

Next, certain investigations and nonlimiting configurations leading to the development of the electrodes and batteries disclosed herein are described for purposes of providing some nonlimiting examples thereof. The investigations were conducted to test whether substituting an MXene anode for a conventional graphite anode, either alone or in combination with using an electrolyte that does not freeze and supports favorable Li⁺ transport, enhances the low-temperature performance of LIBs. The investigations, configurations, and any conclusions derived therefrom, are for providing context for the purpose of understanding various aspects of the electrodes, batteries, electrolytes, and associated methods, components, and products disclosed herein.

In an argon (Ar) filled glove box, electrolytes were prepared by dissolving lithium salts into solvents. A 1.8 M solution of lithium bis(fluorosulfonyl)imide (LiFSI, TCI America) in dipropyl ether (DPE, Sigma-Aldrich) was prepared. The DPE solvent was dried in contact with molecular sieves for one day at 25° C. in an Ar-filled glovebox. For comparison, a conventional electrolyte containing 1.0 M LiPF₆ in a mixture of ethylene carbonate (EC) and ethyl methyl carbonate (EMC) (Sigma-Aldrich, 1:1 v/v, battery grade) was used.

To prepare the MXene electrodes and graphite (Gr) electrodes, a mixture of MXene (Ti₃C₂Tₓ, Anasori Research Lab) or Gr powder, respectively, Super P carbon (Timcal), and polyvinylidene fluoride (PVDF, Kynar HSV-900) was dissolved with mass ratio of 8:1:1 in N-Methyl Pyrrolidone (NMP) and homogenized using a planetary centrifuge at 1600 rpm for thirty minutes to form a slurry. The slurry was cast on copper foil using a doctor blade technique and dried at 80° C. in a vacuum oven for 24 hours. The dried electrode sheet was punched into 12 mm diameter disks for cell assembly, with a MXene loading of 1.5 mg/cm².

CR2032 stainless-steel coin cells were assembled for each type of electrolyte and electrode, using the prepared MXene or graphite (Gr) as the anode (12 mm diameter disk), lithium-copper foil (14 mm diameter, 20 μm thick Li) as the cathode, and a Celgard polypropylene separator (16 mm diameter disk). Each anode half-cell contained 30 μL of the electrolyte. The C rate for cycling tests was determined based on the theoretical capacities of the materials. The theoretical capacity of graphite is 374 mAh g⁻¹, while the theoretical capacity of MXene (Ti₃C₂) was assumed to be 200 mAh g⁻¹. For instance, a C/10 rate means the battery is charged or discharged at a current that would fully charge or discharge in 10 hours. Cells were cycled using an Arbin cycler at a C/10 rate for extended cycling tests at room temperature (about 15° C. to about 25° C., typically about 28-23° C.), −25° C., and −50° C. At −70° C., the cells were cycled at a C/50 rate, and at −80° C., a C/75 rate was used, reflecting the slower electrochemical kinetics at these extreme temperatures. The specific current densities were calculated based on the mass of active material in each electrode and the theoretical capacity of each material.

Cyclic voltammetry (CV) was performed using a BioLogic Potentiostat, with scan rates ranging from 0.5 to 3 mV s⁻¹. The CV measurements were conducted using coin cells with different potential ranges for the two materials: 0.01 V to 3.0 V vs. Li/Li⁺ for the MXene electrode and 0.01 V to 1.5 V vs. Li/Li⁺ for the graphite electrode.

The Li⁺ storage behavior of the MXene electrode was analyzed through CV measurements at various scan rates ranging from 0.5 to 3 mV s⁻¹ in the DPE electrolyte. The CV curves showed distinct redox peaks corresponding to different redox reactions occurring at the MXene electrode. These peaks indicate the complex redox behavior of MXene. To further understand the nature of these redox reactions, a power-law relationship between the peak current (iₚ) and scan rate (v) was examined using the equation iₚ=αv^{b}, where b values close to 1 indicate a surface-controlled (capacitive) process, while those near 0.5 suggest a diffusion-controlled process; values of 0.5 to 1 inclusive represent a transitional area where both mechanisms may contribute. This predominance of surface-controlled capacitive processes is further supported by high b values observed. The b values for all peaks were above 0.8 (with specific values of 0.893, 0.841, 0.973, and 0.869), indicating that these redox reactions are predominantly surface-controlled, characteristic of pseudocapacitive behavior, with only minor contributions from diffusion processes.

For comparison, CV measurements were performed on a graphite electrode, and the corresponding b value was found to be about 0.5. This lower value indicates diffusion-controlled Li⁺ intercalation, the characteristic lithium-ion storage mechanism of conventional graphite. The contrast between MXene and graphite highlights the fundamental difference in their charge storage mechanisms: the MXene appears to exhibit surface-controlled pseudocapacitive behavior, while the graphite relies more on solid-state diffusion processes. This comparison emphasizes the advantages of MXene, particularly in conditions where fast charging and high-rate capability are desired.

The CV curve obtained at −60° C. showed a significant reduction in current response compared to room temperature, indicating slower electrochemical kinetics under these extreme conditions. Despite this, a broad oxidative peak demonstrated that the MXene electrode maintained some electrochemical activity even at very low temperatures. Nevertheless, the consistent shape of the CV curves across different scan rates suggested that MXene remains an effective anode material even under cold conditions. The stable and efficient ion storage mechanisms observed in MXene at room temperature and −60° C. highlight their potential as advanced anode materials for LIBs, particularly in applications with critical low-temperature performance. These findings underscore the robust pseudocapacitive nature of MXene electrodes, enabling them to retain electrochemical functionality across various temperatures.

Galvanostatic cycling was conducted at various temperatures to evaluate the capacity retention and performance of the two different anode materials, Gr and MXene, paired with two different electrolytes: the conventional EC/EMC electrolyte and the new DPE-based electrolyte described above. The primary objective was to determine the impact of low temperatures on the electrochemical performance of these materials, with a particular focus on their capacity retention. The data obtained showed that both the graphite and MXene anodes exhibited stable performance at room temperature with the EC/EMC electrolyte. The graphite anode maintained a specific capacity close to 360 mAh/g, while the MXene anode showed a lower initial capacity of 190 mAh/g. However, the performance of both the graphite and MXene anodes deteriorated significantly as the temperature decreased. At −25° C., the graphite anode retained only 8% of its room temperature capacity, indicating a sharp decline in performance. This dramatic reduction can likely be attributed to the solidification and increased viscosity of the conventional EC/EMC electrolyte at low temperatures, which impedes the mobility of lithium ions and raises the internal resistance within the battery. The solid-state diffusion of lithium ions within the graphite anode also likely becomes sluggish at these low temperatures, further compounding the capacity loss. In contrast, the MXene anode demonstrated better capacity retention of approximately 52% at −25° C. This enhanced performance is likely due to the surface-controlled redox reactions in MXenes, which exhibit faster kinetics compared to the solid-state diffusion-dominated intercalation process in graphite. These surface reactions are believed to allow MXene to maintain more effective lithium-ion transport even as the ionic conductivity of electrolytes decreases. Despite this advantage, both the graphite and MXene anode materials experienced near-total capacity loss at −50° C., with the charge capacity dropping to almost zero. This suggests that the EC/EMC electrolyte is fundamentally inadequate at such low temperatures, as its solidification and the resulting internal resistance apparently severely limit the electrochemical kinetics of the battery.

Similar investigations were conducted relating to the performance of the Gr and MXene anodes with the DPE-based electrolyte described above. DPE was chosen as the electrolyte for these experiments due to its low freezing point of −122° C., ensuring that the electrolyte remains liquid even at ultra-low temperatures. Yet at −50° C., the graphite anode exhibited a dramatic decline in performance, retaining only 3% of its room temperature capacity at this temperature. This poor retention is believed to be caused by the sluggish kinetics of lithium-ion intercalation in graphite at low temperatures, likely dominated by solid-state diffusion. In contrast, the MXene anode performed better under the same conditions. At −50° C., the MXene anode retained 20% of its room temperature capacity. Even at −70° C., the MXene anode cell retained a capacity of 31.7 mAh g⁻¹ with C/50. Without wishing to be bound by theory, it is believed that this reasonable capacity retention at ultra-low temperatures may be attributable to the surface-controlled redox reactions characteristic of MXenes and/or the pseudocapacitive nature of MXenes.

Thus, from these investigations, several new and useful aspects relating to ultra-low temperature rechargeable batteries can be observed. In some aspects, an electrochemical cell having an anode containing MXene performs better at low and extremely low temperatures. In some aspects, a low-temperature electrolyte of DPE-based electrolyte containing dipropyl ether also improves performance of an electrochemical cell at low and extremely low temperatures. The MXene is preferably Ti₃C₂T_{X} wherein T is one of Cl, B, F, Br, O, and OH. In anodes with Ti₃C₂Tₓ, the x is preferably in the range of 1-4. Other new and useful aspects may also be present, as may be apparent from the descriptions and drawings herein.

As previously noted above, though the foregoing detailed description describes certain aspects of one or more particular embodiments of the invention, alternatives could be adopted by one skilled in the art. For example, the electrodes, batteries, electrolytes, and/or their components could differ in appearance and construction from the embodiments described herein and shown in the drawings, functions of certain components of the electrodes, batteries, and/or electrolytes could be performed by components of different construction but capable of a similar (though not necessarily equivalent) function, and various materials could be used in the fabrication of the electrodes, batteries, electrolytes, and/or their components. As such, and again as was previously noted, it should be understood that the invention is not necessarily limited to any particular embodiment described herein or illustrated in the drawings.

1. An electrode for a lithium-ion battery, the electrode comprising MXene, wherein the MXene is Ti₃C₂Tₓ, where Ti₃ denotes three layers of Ti, C₂ denotes two layers of carbon interleaved with the three layers of Ti, and Tₓ denotes surface terminations of F, O, OH, and/or Cl.

2. The electrode of claim 1, wherein the electrode comprises a mixture of the Ti₃C₂Tₓ, carbon, and a binder.

3. The electrode of claim 2, wherein the binder comprises and polyvinylidene fluoride (PVDF).

4. The electrode of claim 2, wherein electrode comprises a sheet of the mixture of Ti₃C₂Tₓ, carbon, and binder.

5. The electrode of claim 1, wherein the electrode is an anode of a lithium-ion battery.

6. A lithium-ion battery comprising an electrode comprising MXene, wherein the MXene is Ti₃C₂Tₓ where Ti₃ denotes three layers of Ti, C₂ denotes two layers of carbon interleaved with the three layers of Ti, and Tₓ denotes surface terminations of F, O, OH, and/or Cl.

7. The lithium-ion battery of claim 6, wherein the electrode comprises a mixture of the MXene, carbon, and a binder.

8. The lithium-ion battery of claim 6, further comprising a DPE-based electrolyte comprising dipropyl ether.

9. The lithium-ion battery of claim 8, wherein the DPE-based electrolyte comprises Lithium bis(fluorosulfonyl)imide (LiFSI) dissolved in the dipropyl ether.

10. The lithium-ion battery of claim 9, wherein at −50°C, the electrode is an anode and retains about 20% of its specific capacity (mAh/g) at room temperature.

11. The lithium-ion battery of claim 10, wherein the electrode is an anode and the lithium-ion battery further comprises a cathode and a porous separator that electronically separates the cathode from the anode and allows ion migration from either of the cathode and the anode to the other of the cathode and the anode.

12. The lithium-ion battery of claim 11, wherein the lithium-ion battery is a rechargeable battery.

13. A rechargeable battery comprising:
an anode comprising MXene;
a cathode; and
a DPE-based electrolyte ionically coupling the anode with the cathode, wherein the electrolyte is a solution of lithium bis(fluorosulfonyl)imide (LiFSI) in dipropyl ether.

14. The rechargeable battery of claim 13, wherein the MXene is Ti₃C₂Tₓ where Ti₃ denotes three layers of Ti, C₂ denotes two layers of carbon interleaved with the three layers of Ti, and Tₓ denotes surface terminations of F, O, OH, and/or Cl.

15. The rechargeable battery of claim 14, wherein the anode comprises the MXene, carbon, and PVDF.

16. The rechargeable battery of claim 13, wherein the rechargeable battery is a lithium-ion battery.

17. A low-temperature electrolyte for an electrochemical cell, the electrolyte comprising a sufficient quantity of dipropyl ether to not freeze at a temperature of −70°C.

18. The low-temperature electrolyte of claim 17, wherein the electrolyte comprises a solution of lithium bis(fluorosulfonyl)imide (LiFSI) and the dipropyl ether.

19. The low-temperature electrolyte of claim 18, wherein the electrolyte consists of the solution of lithium bis(fluorosulfonyl)imide (LiFSI) and the dipropyl ether.
